(19) United States
(12) Patent Application Publication
(10) Pub. No.: US 2005/0248778 A1
(43) Pub. Date: Nov. 10, 2005

(54) Image forming method and image forming apparatus with determination of set value

(75) Inventor: Yong-im Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/123,078

(22) Filed: May 6, 2005

(30) Foreign Application Priority Data
May 7, 2004 (KR) 10-2004-0032206

(51) Int. Cl. G06F 3/12; G06F 15/00

(52) U.S. Cl. 358/1.2; 358/1.13

(57) ABSTRACT

An image forming method and apparatus with determination of set values including the steps of grouping image data into a plurality of groups by resolution, determining picture sizes of the image data of a first group, of which the image data have a resolution smaller than a predetermined resolution from among the plurality of groups, and outputting the image data of the first group, of which the picture sizes have been determined. In this way, by determining the picture sizes and the output resolution modes suitable for the resolutions of the image data group, it is possible to eliminate the undesired steps of individually selecting pictures, picture sizes, and output resolution modes, and prevent the image data from being erroneously output.

### CROSS-REFERENCE TO RELATED APPLICATIONS

This application claims the benefit under 35 U.S.C. §119(a) of Korean Patent Application No. 10-2004-0032206 filed in the Korean Intellectual Property Office on May 7, 2004, the entire disclosure of which is incorporated herein by reference.

### BACKGROUND OF THE INVENTION

1. Field of the Invention

The present invention relates to an image forming apparatus such as a photo printer. More particularly, the present invention relates to an image forming method and an image forming apparatus with determination of set values in which image data are output by determining the set values of the image data by resolution.

2. Description of the Related Art

Generally, when users take pictures with digital cameras, the resolution is set to the lowest value so as to store more data. Also, since pictures taken with digital cameras can be confirmed on the spot, most of the unacceptable pictures are deleted immediately. Therefore, most of the picture data stored in digital cameras has the lowest resolution and are those that are desired by the users.

Also, image forming apparatuses such as photo printers and the like, that have recently come onto the market, directly read image data from memory cards of the digital cameras and display the read data in display windows of the liquid crystal display devices without communicating with computers. The users can select the displayed images, and the image forming apparatuses can then output the selected images following a determination of the picture sizes or the output resolution modes of the selected images.

The image data can have output sizes recommended by resolution, and image data having different resolutions can be stored in the memory cards. Therefore, the users must individually select images and determine picture sizes and output resolution modes of the images so as to output the image data as photographs. Further, since the photographs may be output with picture sizes or output resolution modes that are unsuitable for the image data, problems can result such as the wasting print sheets.

Accordingly, a need exists for a system and method for automatically determining picture sizes and output resolution modes suitable for the resolutions of an image.

### SUMMARY OF THE INVENTION

The present invention solves the above and other problems, and provides an image forming method with determination of set values in which picture sizes and output resolution modes can be determined to be suitable for resolutions of image data in a memory.

The present invention also provides an image forming apparatus with determination of set values in which picture sizes and output resolution modes can be determined to be suitable for resolutions of image data in a memory.

According to an aspect of the present invention, an image forming method with determination of set values is provided comprising the steps of grouping image data into a plurality of groups by resolution, determining picture sizes of the image data of a first group, of which the image data have a resolution smaller than a predetermined resolution, from among the plurality of groups, and outputting the image data of the first group of which the picture sizes have been determined.

According to another aspect of the present invention, an image forming apparatus with determination of set values is provided comprising a data grouping unit for grouping image data into a plurality of groups by resolution, a set value determination unit for determining picture sizes of the image data of a first group, of which the image data have a resolution smaller than a predetermined resolution, from among the plurality of groups, and an image output unit for outputting the image data of the first group of which the picture sizes has been determined.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart illustrating an image forming method with determination of set values according to an embodiment of the present invention;

FIG. 2 is a diagram illustrating a set value table of output resolution modes and picture sizes sorted by resolution according to an embodiment of the present invention; and

FIG. 3 is a block diagram illustrating an image forming apparatus with determination of set values according to an embodiment of the present invention.

Throughout the drawings, like reference numerals will be understood to refer to like parts, components and structures.

### DETAILED DESCRIPTION OF EXEMPLARY EMBODIMENTS

Hereinafter, exemplary embodiments of an image forming method with determination of set values according to the present invention will be described in detail with reference to the attached drawings.

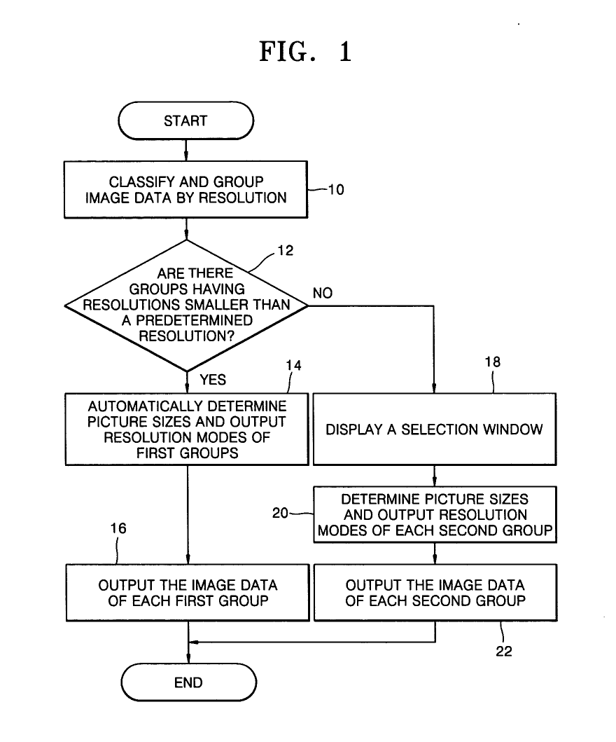

FIG. 1 is a flowchart illustrating an image forming method with determination of set values according to an embodiment of the present invention.

In the exemplary method of FIG. 1, image data is first classified and grouped by resolution at step 10. When the image data, having various resolutions stored in a mobile storage device such as a universal serial bus (USB) drive, a memory card, and the like, are input to the image forming apparatus such as a photo printer, and the like, the image data are classified and grouped into a plurality of groups, each group including image data having the same resolution.

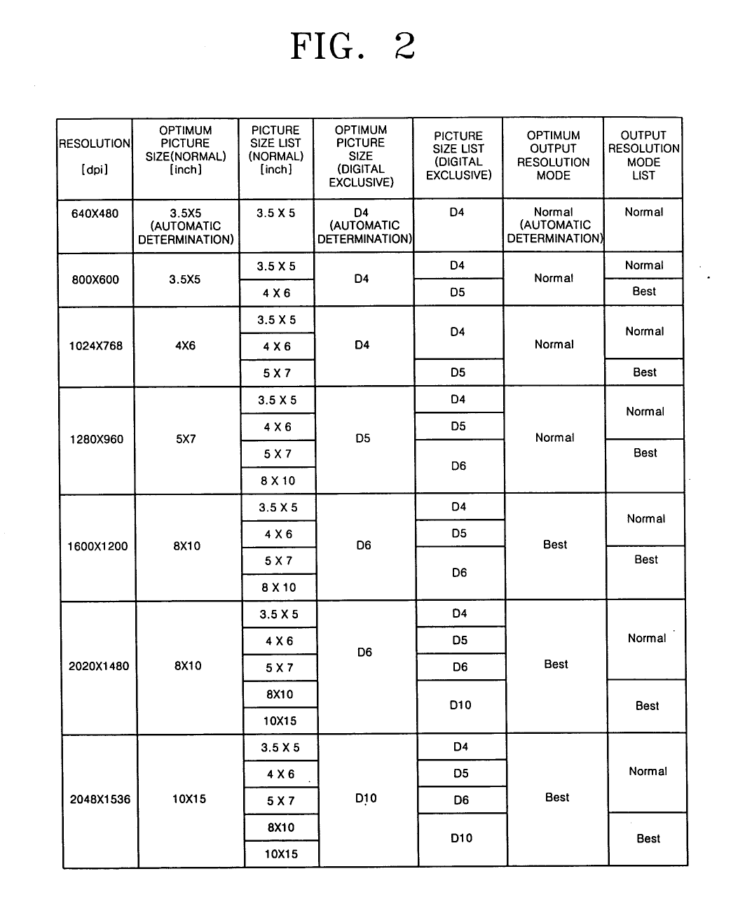

FIG. 2 is a diagram illustrating an example of a set value table of output resolution modes and picture sizes sorted by resolution. As shown in FIG. 2, the image data having resolutions of “640×480”, “800×600”, “1024×768”, “1280×960”, “1600×1200”, “2020×1480”, and “2048×1536”, are grouped into the plurality of groups, of which each includes the image data having the same resolution. For example, the image data can have resolutions as shown in the following Table 1.

TABLE 1

| Image data | resolution |
|---|---|
| IMAGE 1 | 640 × 480 |
| IMAGE 2 | 1024 × 768 |
| IMAGE 3 | 1280 × 960 |
| IMAGE 4 | 1280 × 960 |
| IMAGE 5 | 1024 × 768 |
| IMAGE 6 | 640 × 480 |

In Table 1, “IMAGE 1” and “IMAGE 6” constitute a group, because “IMAGE 1” and “IMAGE 6” have the resolution of “640×480”. Further, because “IMAGE 2” and “IMAGE 5” have the resolution of “1024×768”, “IMAGE 2” and “IMAGE 5” constitute another group. Furthermore, because “IMAGE 3” and “IMAGE 4” have the resolution of “1280×960”, “IMAGE 3” and “IMAGE 4” constitute another group.

Returning to FIG. 1, after step 10, the groups of image data having a resolution smaller than a predetermined resolution are examined at step 12. At this time, the predetermined resolution is determined with reference to the lowest resolution of the grouped image data. For example, as shown in FIG. 2, the lowest resolution of the grouped image data is “640×480”, therefore, “640×480” is set as the predetermined resolution. Accordingly, when the resolution of “640×480 is set as the predetermined resolution, the group of image data having the resolution of “640×480” is examined. From Table 1, it can be shown that the image data of “IMAGE 1” and “IMAGE 6” are grouped into the group having the resolution of “640×480”.

At step 12, the group of the image data having a resolution smaller than the predetermined resolution is examined, and at step 14, picture sizes and output resolution modes of the image data of the first group having a resolution smaller than the predetermined resolution are determined. Here, the picture sizes and the output resolution modes of the image data of the first group are automatically determined. For example, as shown in FIG. 2, if the lowest resolution of “640×480” is set as the predetermined resolution, it can be confirmed from Table 1 that the group having the lowest resolution of “640×480” is the first group. Then, the picture size of the image data of “IMAGE 1” and “IMAGE 6” in the first group is automatically determined. That is, the picture size of “IMAGE 1” and “IMAGE 6” having the resolution of “640×480” in FIG. 2 is automatically determined to be a predetermined optimum size of “3.5×5” without requiring a user's selection.

As shown in FIG. 2, a digital-exclusive size may also be determined as the optimum picture size. The digital-exclusive size is a digital standard in which both of a width-and-length ratio of images taken with a digital camera, and a width-and-length ratio of print sheets coincide with each other. A “D4” value indicates a size of approximately 15.2×11.43 cm. Therefore, “D4” is the digital-exclusive size that is automatically determined as the picture size of the first group having the resolution of “640×480” in FIG. 2 without requiring a user's selection.

When the group of image data having the predetermined data is the first group having the resolution of “640×480”, an output resolution mode of “IMAGE 1” and “IMAGE 6” of the first group is automatically determined. The output resolution modes are predetermined by classifying image qualities of images output from the image forming apparatus by grade. Generally, “Normal” means the output of images with a normal quality, and “Best” means the output of images with a best quality. Further, the output resolution modes may be further classified by such names as “Draft”, “Superfine,” and so forth. The “Normal” designation corresponding to the optimum output resolution mode is automatically set as the output resolution mode of the first group having the resolution of “640×480” without requiring a user's selection.

Returning to FIG. 1, after step 14, the image data of the first group, of which the picture size and the output resolution mode have been determined, are output at step 16. The image data of the first group are transmitted to a spooler, and the images are printed in the order of image data as transmitted to the spooler. The spooler comprises a buffer memory and is an auxiliary device for allowing the image forming apparatus to continuously output images. The image data of the first group transmitted to the spooler are printed with the automatically-determined picture size and output resolution mode.

A selection window can be displayed to show a picture size list and an output resolution mode list for second, third and additional groups of image data having resolutions larger than the predetermined resolution at step 18. The selection window is displayed to allow a user to select the picture sizes or the output resolution modes of the second, third and additional groups having resolutions larger than the predetermined resolution. The selection window may be displayed in the form of a set value table as shown in FIG. 2.

Step 18 of FIG. 1 will now be described with reference to FIG. 2 and Table 1. If the predetermined resolution is “640×480”, the picture sizes of the image data having the resolutions of “800×600”, “1024×768”, “1280×960”, “1600×1200”, “2020×1480”, and “2048×1536”, that are larger than the predetermined resolution are not automatically determined. Therefore, as shown in FIG. 2, the selection window includes a list of picture sizes corresponding to the image data having the resolutions of “800×600”, “1024×768”, “1280×960”, “1600×1200”, “2020×1480”, and “2048×1536”. Further, the selection window also includes the optimum picture sizes suitable when the image data having the resolutions of “800×600”, “1024×768”, “1280×960”, “1600×1200”, “2020×1480”, and “2048×1536” are output. Therefore, the user may confirm the optimum picture sizes and select the optimum picture size, or may select the picture size with reference to the picture size list. As shown in FIG. 2, the selection window includes general picture sizes, but the selection window may also include digital-exclusive picture sizes in addition to the general picture sizes. Therefore, when the digital-exclusive picture sizes and the optimum picture sizes are displayed in the selection window, the user can select the digital-exclusive picture sizes and the optimum picture sizes in the same way as selecting the general picture sizes.

As the picture sizes of the image data having the resolutions of “800×600”, “1024×768”, “1280×960”, “1600×1200”, “2020×1480”, and “2048×1536” are not automatically determined, the output resolution modes thereof are also not automatically determined. Therefore, as shown in FIG. 2, the selection window further includes the output resolution mode list corresponding to the image data having the resolutions of “800×600”, “1024×768”, “1280×960”, “1600×1200”, “2020×1480”, and “2048×1536”. Further, the selection window includes the optimum output resolution modes suitable for each case where the image data having the resolutions of “800×600”, “1024×768”, “1280×960”, “1600×1200”, “2020×1480”, and “2048×1536” are output. Therefore, the user may confirm the optimum output resolution modes and select an optimum output resolution modes, or may select an output resolution mode with reference to the output resolution mode list.

Returning to FIG. 1, after step 18, the picture sizes and the output resolution modes of the second, third and additional groups are determined in accordance with the user's selection through the selection window at step 20.

Step 20 will now be described with reference to FIG. 2 and Table 1. When the predetermined resolution is the lowest resolution of “640×480,” the second, third and additional groups having resolutions larger than the predetermined resolution includes one group comprising “IMAGE 2” and “IMAGE 5” and another group comprising “IMAGE 3” and “IMAGE 4”. The group of “IMAGE 2” and “IMAGE 5” have the resolution of “1024×768”, and the group of “IMAGE 3” and “IMAGE 4” have the resolution of “1280×960”. When the selection window shown in FIG. 2 is displayed, the user can select the picture size and the output resolution mode of the group having the resolution of “1024×768”. When the user selects “5×7” as the picture size and “Best” as the output resolution mode of the group having the resolution of “1024×768”, the picture size and the output resolution mode of this group are determined as “5×7” and “Best”, respectively, through the user's selection of “5×7” and “Best”. Further, when the user selects “8×10” as the picture size of the group having the resolution of “1280×960” and “Normal” as the output resolution mode, the picture size and the output resolution mode of this group are determined as “8×10” and “Normal”, respectively, through the user's selection of “8×10” and “Normal”.

Returning to FIG. 2, after step 20, the image data of each second, third and additional group are output at step 22. When the picture sizes and the output resolution modes are determined through the user's selection at step 20, the image data of the second, third and additional groups are transmitted to the spooler, and the images are printed in the order of the images as transmitted to the spooler.

Hereinafter, an image forming apparatus with determination of set values according to an embodiment of the present invention will be described in detail with reference to the attached drawings.

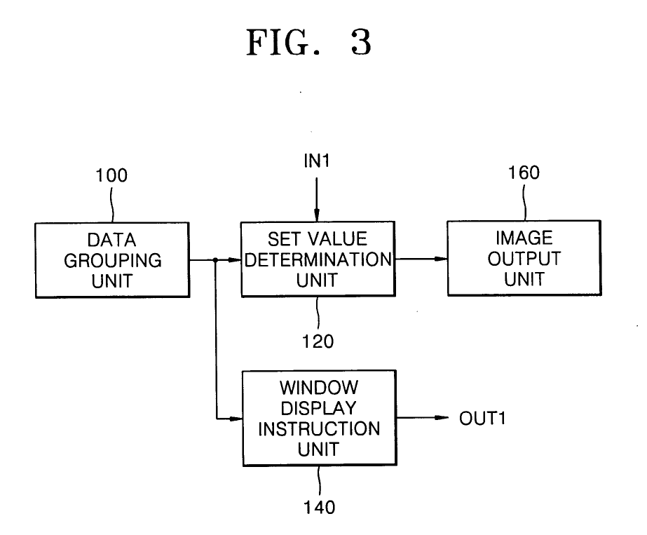

FIG. 3 is a block diagram illustrating an image forming apparatus with determination of set values according to an embodiment of the present invention, wherein the image forming apparatus comprises a data grouping unit 100, a set value determination unit 120, a window display instruction unit 140, and an image output unit 160.

The data grouping unit 100 classifies and groups image data by resolution. If the image data, having various resolutions and being stored in a mobile storage device such as a universal serial bus (USB) drive, a memory card, and the like, are input to the image forming apparatus, the data grouping unit 100 classifies and groups the image data by resolution and outputs the grouping result to the set value determination unit 120 and the window display instruction unit 140.

In response to the grouping result of the data grouping unit 100, the set value determination unit 120 determines the picture sizes and the output resolution modes of the image data of the first group, the first group having resolutions smaller than the predetermined resolution among the grouped image data, and outputs the determination result to the image output unit 160.

The set value determination unit 120 automatically determines the picture sizes of the output resolution modes of the image data of the first group. At this time, the predetermined resolution is determined with reference to the lowest resolution of the grouped image data. For example, as shown in FIG. 2 and Table 1, if the lowest resolution of the grouped image data is “640×480”, then “640×480” is set as the predetermined resolution. When the group having the resolution of “640×480” is input as the group having the predetermined resolution, the set value determination unit 120 automatically determines “3.5×5” as the picture size of the image data “IMAGE 1” and “IMAGE 6” in the first group without requiring a user's selection. Further, the set value determination unit 120 automatically determines “Normal” as the output resolution mode of the image data “IMAGE 1” and “IMAGE 6” in the first group also without requiring a user's selection.

The set value determination unit 120 determines the picture sizes and the output resolution modes of each second, third and additional group through a user's selection from the selection window. For example, when the user arbitrarily selects one picture size or one output resolution mode of the picture sizes or the output resolution modes displayed on the selection window shown in FIG. 2, the selection data of the user are input to the set value determination unit 120 through an input terminal IN1. The set value determination unit 120 then determines the picture sizes and the output resolution modes using the user's selection data. For example, as shown in FIG. 2 and Table 1, when the predetermined resolution is “640×480”, the second, third and additional groups having resolutions larger than the predetermined resolution include one group having “IMAGE 2” and “IMAGE 5”, and another group having “IMAGE 3” and “IMAGE 4”. When the user selects “5×7” as the picture size of the group having the resolution of “1024×768” and selects “Best” as the output resolution mode thereof, the set value determination unit 120 determines “5×7” and “Best”, respectively, as the picture size and the output resolution mode of this group in response to the user's selection of “5×7” and “Best”. Further, when the user selects “8×10” as the picture size of the group having the resolution of “1280×960” and selects “Normal” as the output resolution mode thereof, the set value determination unit 120 determines “8×10” and “Normal”, respectively, as the picture size and the output resolution mode of this group in response to the user's selection of “8×10” and “Normal”.

Returning to FIG. 3, the window display instruction unit 140 provides a display of the selection window in which the picture size list and the output resolution mode list of the second, third and additional groups, having resolutions larger than the predetermined resolution among the image data grouped by the data grouping unit 100, is displayed, and outputs the instruction result as a display instruction signal through an output terminal OUT1. The selection window is displayed to allow the user to select the picture sizes or the output resolution modes of the second, third and additional groups having resolutions larger than the predetermined resolution. The selection window may be displayed in the form of the set value table as shown in FIG. 2. When the display instruction signal of the window display instruction unit 140 is output, the selection window is displayed on a display screen of the image forming apparatus. For example, when the selection window including the set value table shown in FIG. 2 is displayed, the user can select the picture sizes from the picture size list of the image data having the resolution of “800×600”, “1024×768”, “1280×960”, “1600×1200”, “2020×1480”, and “2048×1536”, and select the output resolution modes from the output resolution mode list. As described above, the user's selection data are input to the set value determination unit 120 through the input terminal IN1.

The image output unit 160 outputs the image data of the first group, of which the picture size and the output resolution mode have been automatically determined, and/or the image data of each second, third and additional group, of which the picture size and the output resolution mode has been determined through the user's selection. When the image data of the first group and the second, third and additional groups, of which the picture sizes and the output resolution modes have been determined by the set value determination unit 120 automatically or through the user's selection, are input to the spooler as a buffer storage device, the image output unit 160 outputs the image data of the first group and the second, third and additional groups with the determined picture sizes and output resolution modes.

As described above, in the image forming method and apparatus with determination of set values according to the present invention, since the picture sizes and the output resolution modes can be automatically determined, it is possible to eliminate the undesired additional steps of individually setting the output resolution modes and the picture sizes of the pictures to be printed.

In addition, the present invention can prevent the waste of print sheets due to erroneous selection of picture size when printing images with the image forming apparatus.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

1. An image forming method with determination of set values, the method comprising the steps of:
grouping image data by resolution into a plurality of groups;
determining picture sizes of the image data of a first group, of which the image data have a resolution that is smaller than a predetermined resolution from among the plurality of groups; and
outputting the image data of the first group, of which the picture sizes have been determined.

2. The image forming method according to claim 1, wherein the step of determining the picture sizes of the image data of the first group is automatically performed.

3. The image forming method according to claim 1, wherein the step of determining the picture sizes further comprises the step of:
determining output resolution modes of the image data of the first group.

4. The image forming method according to claim 3, wherein the step of determining the output resolution modes of the image data of the first group is automatically performed.

5. The image forming method according to claim 3, wherein the step of outputting the image data of the first group further comprises the step of:
outputting the image data of the first group, of which the output resolution modes have been automatically determined.

6. The image forming method according to claim 5, wherein the step of outputting the image data of the first group, of which the output resolution modes have been automatically determined.

7. The image forming method according to claim 1, further comprising the steps of:
displaying a selection window on which a picture size list and an output resolution mode list for at least a second group, of which the image data have a resolution larger than the predetermined resolution from among the plurality of groups, are displayed;
determining picture sizes of the second group in accordance with selection data input through the selection window; and
outputting the image data of the second group, of which the picture sizes have been determined.

8. The image forming method according to claim 7, wherein the step of determining the picture sizes of the second group further comprises the step of:
determining output resolution modes of the image data of the second group in accordance with the selection data input through the selection window.

9. The image forming method according to claim 8, wherein the step of outputting the image data of the second group further comprises the step of:
outputting the image data of the second group, of which the output resolution modes have been determined.

10. The image forming method according to claim 1, wherein the predetermined resolution is determined with reference to a lowest resolution of the resolutions of the grouped image data.

11. An image forming apparatus with determination of set values, the apparatus comprising:
a data grouping unit for grouping image data by resolution into a plurality of groups;
a set value determination unit for determining picture sizes of the image data of a first group, of which the image data have a resolution smaller than a predetermined resolution from among the plurality of groups; and
an image output unit for outputting the image data of the first group, of which the picture sizes have been determined.

12. The image forming apparatus according to claim 11, wherein the set value determination unit automatically determines the picture sizes of the image data of the first group.

13. The image forming apparatus according to claim 11, wherein the set value determination unit is further configured toy determine output resolution modes of the first group.

14. The image forming apparatus according to claim 13, wherein the set value determination unit is further configured to automatically determine the output resolution modes of the first group.

15. The image forming apparatus according to claim 11, further comprising:
a window display instruction unit for providing a selection window on which a picture size list and an output resolution mode list for at least a second group, of which the image data have a resolution larger than the predetermined resolution from among the plurality of groups, are displayed, wherein,
the set value determination unit is configured to determine a picture size of the second group in accordance with the selection data input through the selection window, and
the image output unit is configured to output the image data of the second group.

16. The image forming apparatus according to claim 15, wherein the set value determination unit is further configured to determine an output resolution mode of the second group in accordance with the selection data input through the selection window.

17. The image forming apparatus according to claim 11, wherein the predetermined resolution is determined with reference to a lowest resolution of the resolutions of the grouped image data.

18. An image forming method with determination of set values, the method comprising the steps of:
determining predetermined picture sizes of image data having a resolution that is smaller than a predetermined resolution; and
outputting the image data of which the predetermined picture sizes have been determined.

19. An image forming apparatus with determination of set values, the apparatus comprising:
a set value determination unit for determining predetermined picture sizes of image data having a resolution smaller than a predetermined resolution; and
an image output unit for outputting the image data of which the predetermined picture sizes have been determined.
